(19) United States
(12) Patent Application Publication
(10) Pub. No.: US 2007/0138306 A1
(43) Pub. Date: Jun. 21, 2007

(54) Printed marking hidden authentication

(75) Inventors: Andrei Obrea, Seymour, CT (US); Robert A. Cordery, Danbury, CT (US); John G. Desmond, Fairfield, CT (US); Judith D. Auslander, Westport, CT (US); Steven M. Kaye, Weston, CT (US); Cindy Mangiameli, Southbury, CT (US); Michael P. Swenson, Danbury, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/311,741

(22) Filed: Dec. 19, 2005

(51) Int. Cl. G06K 19/06; G06K 7/10

(52) U.S. Cl. 235/494; 235/491; 235/468

(57) ABSTRACT

A system for storing information including a first partial portion of a printed marking, and a second partial portion of the printed marking. The printed marking comprises first information in a first information storage format. The first partial portion is printed with a first ink. The second partial portion is intermixed with the first partial portion to form the printed marking. The second partial portion is printed with at least one second different ink. The second ink comprises a metameric ink which becomes excited when exposed to an excitation source such that the printed marking contains second different information in a second different information storage format which can be read when the printed marking is exposed to the excitation source.

### BACKGROUND OF THE INVENTION

1. Field of the Invention

The present invention relates to a printed indicium, marking or document and, more particularly, to a printed indicium, marking or document which is printed with at least two different inks.

2, Brief Description of Prior Developments

Printed documents carry information using at least one predefined set of characters (symbology). An example of symbology used to create documents intended for human reading is an alphabet. Documents intended for machine readability may use barcode symbology for example. Glyphs and other methods of hiding information in images (steganography) are known to exist. Cryptographic methods to ensure authentication and integrity of documents are also known to exist.

In some instances, important printed documents have to demonstrate that they were created by a specific entity (such as a person or organization), possibly on a specific date. A common method of authenticating the source of a document is a digital signature. A digital signature is a method of adding a group of characters to an existing document using cryptographic algorithms and private codes. The result of adding a digital signature to a printed document is an additional group of symbols which are (in known implementations) visible like the rest of the document. These symbols do not carry any of the original message (payload), but they can be used to determine if the payload was created by a specific entity, on a specific date and that it was not altered since it was created. In most cases, the recipient of a printed message is interested only in the payload. However, on occasions, the recipient needs to verify the digital signature to confirm the source of the document and its integrity. In most cases, users of such documents would prefer to “not see” the codes used for authentication and integrity. These codes are considered by many to be “ugly” and they distract the reader from the message being conveyed by the document.

Similarly, some documents use error detection and correction codes to increase the chance of retrieving the document payload, such as when some of the printed areas are not readable due to miss-handling (e.g. dirt, ink smudges, printing defects). Adding error detection and correction codes to a document payload also involves computing and printing characters in addition to the intended message (payload). Like digital signature codes mentioned above, users also prefer not to have to “see” these codes.

Printing indicium, such as linear or 2D bar codes or mail piece indicium, with one ink limits the information capacity of the indicium and also does not allow embedding of covert information. Barcodes are used in many applications for the identification, tracking, and tracing of objects, letters, or packages. Some applications require only very basic information about an object (identity or destination) while other applications require detailed information about an object (e.g. postage paid, origin address, postage meter number, sender, addressee, destination address, weight, date, contents, batch number). Barcodes are also used extensively for the identification of objects for sale; for example the Universal Product Code (UPC), and in many other applications. Such barcodes could, in principle, be expanded to include data about batch numbers, production dates, or expiration dates to aid in product recalls and rotation of product inventory.

Introduction of additional indicium information can be hindered by several factors including: real estate available on the object; existing standardized specification precluding expansion (e.g., PostNet is set as 12 digits); resolution of existing readers and printers; expense and logistics to retrofit existing readers and printers; need for printed indicium schemes (such as a barcode scheme) to conform to the least common denominator user.

### SUMMARY OF THE INVENTION

In accordance with one aspect of the present invention, a system for storing information is provided including a first partial portion of a printed indicium, and a second partial portion of the printed indicium. The printed indicium comprises first information in a first information storage format. The first partial portion is printed with a first ink. The second partial portion is intermixed with the first partial portion to form the printed indicium. The second partial portion is printed with at least one second different ink. The second ink comprises a metameric ink which becomes excited when exposed to an excitation source such that the printed indicium contains second different information in a second different information storage format which can be read when the printed indicium is exposed to the excitation source.

In accordance with another aspect of the present invention, a system for reading hidden information stored in a printed indicium is provided comprising a system for exciting portions of the printed indicium printed containing metameric ink; and a system for reading locations of the excited portions of the printed indicium relative to non-excited portions of the printed indicium in a machine readable information storage format to thereby read the hidden information.

In accordance with one method of the present invention, a method of printing a printed indicium is provided comprising determining first portions of the printed indicium which are to be printed with a first ink and second portions of the printed indicium which are to be printed with a second different ink, wherein the first and second portions provide a first information; printing the first portions with the first ink; and printing the second portions with the second ink, wherein the second ink comprises metameric ink, and wherein positions of the first portions relative to the second portions provide a second machine readable information.

In accordance with another method of the present invention, a method of authenticating a printed indicium is provided comprising reading the printed indicium using a first information reading format; and reading the printed indicium using a second different information reading format, wherein reading the printed indicium using a second different information reading format comprises exciting second portions of the printed indicium with an excitation source and determining locations of the second portions relative to first portions of the printed indicium.

### BRIEF DESCRIPTION OF THE DRAWINGS

The foregoing aspects and other features of the present invention are explained in the following description, taken in connection with the accompanying drawings, wherein:

FIG. 1 is a system diagram of a system for producing a printed indicium or document comprising features of the present invention;

FIG. 2 is a view showing text or indicium of one example of the present invention;

FIG. 3 is a partial chart of hexadecimal representations of some of the characters shown in FIG. 2;

FIG. 4 is an example of the first few bytes of a signature calculated over the document shown in FIG. 2 to be used with the document;

FIG. 5 is a diagram showing sectioning of the characters of the example shown in FIG. 2 for the signals shown in FIG. 4, and illustrating by emphasis the characters printed with two different inks;

FIG. 5A is a diagram showing the text of FIGS. 2 and 5 as three separate illustrative lines of normal daylight text, only characters printed with the second ink, and only characters printed with the first ink, respectively;

FIG. 5B is a diagram showing the text of lines 19 and 20 converted to digital binary digits based upon presence of the first and second inks;

FIG. 5C is a diagram of the line shown in FIG. 5B with spaces removed;

FIG. 5D is a diagram of the line shown in FIG. 5C sectioned into signals and illustrating the signals generated from the groups of bits;

FIG. 6 is a chart of intensity versus wavelength for two examples of Black Fluorescent Ink which could be used as the second ink;

FIG. 7 is a diagram showing one example of a system for reading the printed indicium or document;

FIG. 8 is an image of a form captured with a conventional camera or scanner using normal lighting conditions;

FIG. 9 is an image of the form shown in FIG. 8 captured with a UV camera or scanner with the document exposed to UV light; and

FIG. 10 is the result of processing the images from FIGS. 8 and 9 to extract the hidden second information used for authentication, integrity and/or redundancy of the document or first information in the document.

### DETAILED DESCRIPTION OF THE PREFERRED EMBODIMENTS

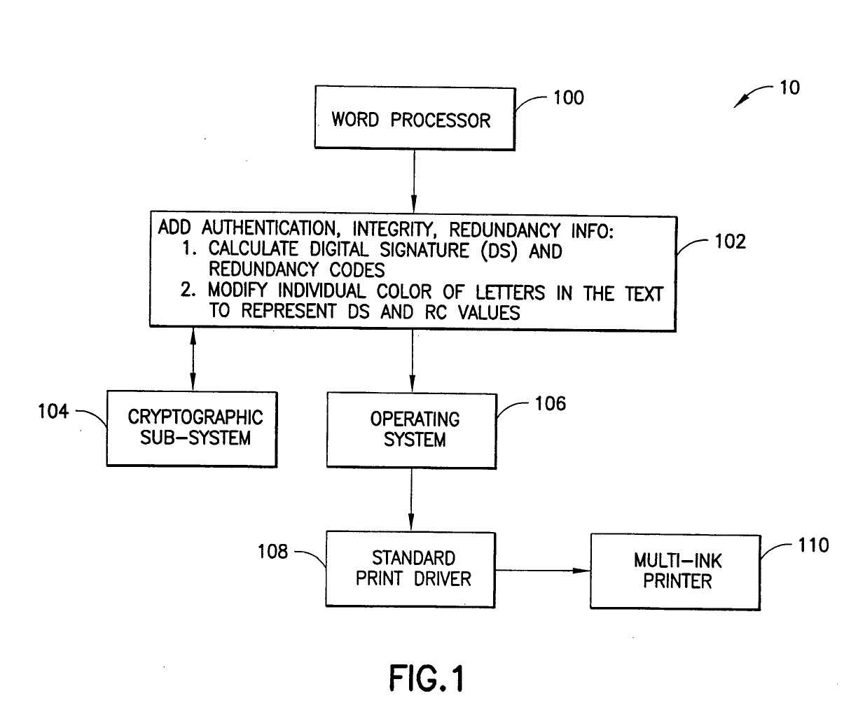

Referring to FIG. 1, there is shown a system diagram of a system 10 for producing a printed indicium incorporating features of the present invention. As used herein, the terms “document” and “indicium” and “marking” are used interchangeably for purposes of describing the invention. Although the present invention will be described with reference to the exemplary embodiments shown in the drawings, it should be understood that the present invention can be embodied in many alternate forms of embodiments. In addition, any suitable size, shape or type of elements or materials could be used.

One type of implementation of a method of the present invention can use Black Fluorescent Ink (BFI) in a printer 110 with two ink cartridges. One ink cartridge can print with regular black ink and the other cartridge can print with Black Fluorescent Ink (BFI). In alternate embodiments, the two inks could have any suitable color in normal daylight. In another alternate embodiment, more than two inks could be provided in the printer 110.

The present invention comprises a process of adding information (such as numeric information) to achieve document authentication, integrity and/or redundancy which may be performed in conjunction with other standard action(s) taken by the user during the process of creating and printing a document. For example, the determination of which element or character of a printed indicium or document to be printed with Black Fluorescent Ink (BFI) can be added to either the Save or Print operations during document creation. This can be transparent to the user. FIG. 1 is an illustration of adding such information just before a Print operation. It is assumed that an initialization step has already taken place when user preferences and crypto-keys were configured appropriately.

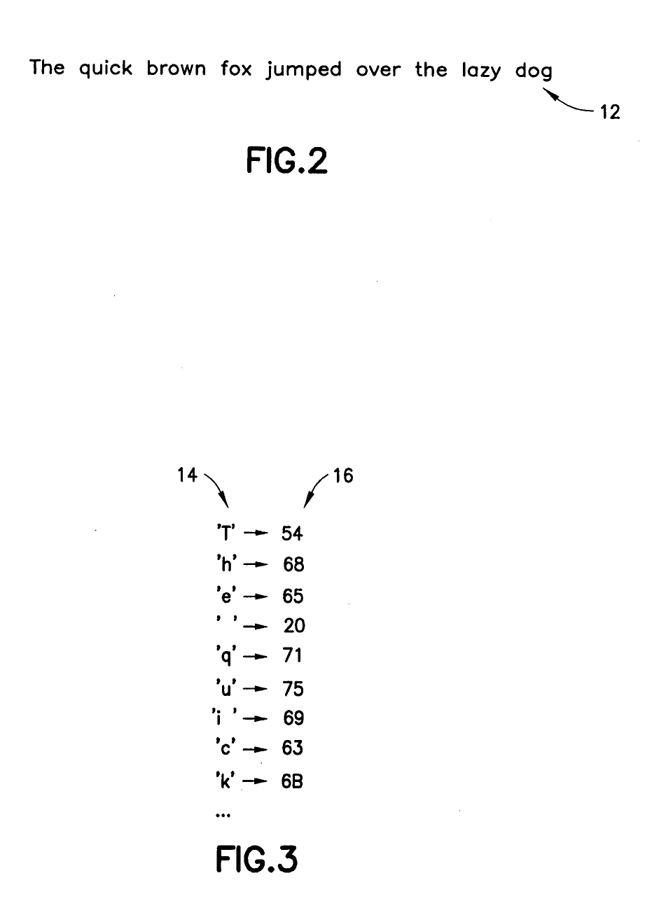

The user of the system creates a document, such as a text document. An example of a text document is shown in FIG. 2. This text is sent from the Word Processor 100 to be printed. A software module 102 can intercept the text and calculate which letters/characters will be printed with BFI. When using a standard printer, one may replace a color ink cartridge with a BFI cartridge. As a result, the software module 102 changes the ink of chosen letters. The system 10 can use a cryptographic sub-system 104. The operating system 106 can send the information to the print driver 108 which sends the information to the printer 110.

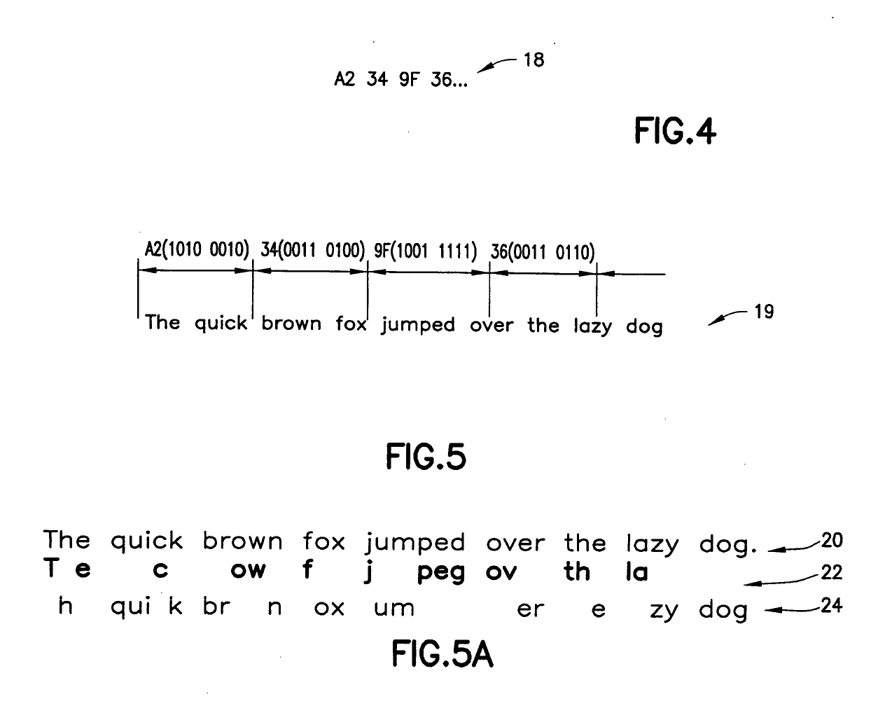

The process of choosing which letters to print with BFI is described next. An example of hexadecimal representations 16 of the first few letters 14 of the text of FIG. 2 is illustrated in FIG. 3. As further described below, these hexadecimal representations (or equivalent representations) can be used after the indicium or marking or document 12 is printed as partial input to algorithms used to calculate digital signatures, Message Authentication Code (MAC) and/or redundancy codes. The characters in the printed indicium or document 12 shown in FIG. 2 can be read such as with a scanner and Optical Character Recognition (OCR) program. The software module 102 can calculate a digital signature, MAC or error correction codes using a numeric representation of the text. For example, as illustrated in FIG. 4, the first few bytes 18 of the signature calculated over the entire document could be “A2 34 94 36”.

In the next step, the information that needs to be encoded into the document (in this example “A2 34 9F 36”) is used to decide which letters of the document will be printed with BFI; leaving the rest of the letters or characters to be printed with regular black ink. The result will be a document which will have a substantially same aspect as a document printed with solely regular black ink when looked at using normal light. However, under Ultraviolet (UV) light certain letters of the text will appear to have a different color.

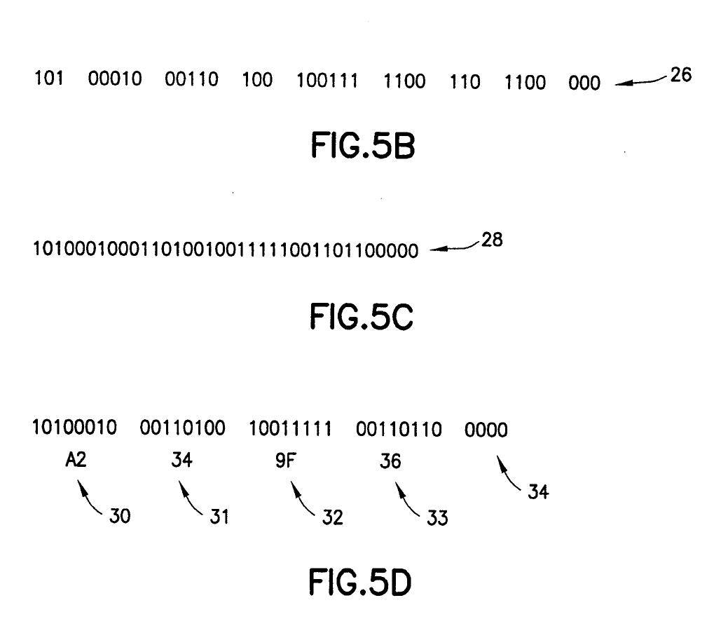

In FIG. 5, the characters of the text shown in FIG. 2 are which are to be encoded with a digital or binary “1” were selected to be printed with BFI and are shown bold. In the actual implementation, the text under normal light will not be altered and bold will not be added to the characters printed with BFI ink; nor will there be any other visible aspect differences of the elements printed with BFI and elements printed with non-BFI ink in the document. Line 20 in FIG. 5A shows how the text would appear in normal daylight. Line 22 shows merely the letters printed with the second ink; the BFI. In particular, the letters are T, e, c, o, w, f, j, p, e, d, o, v, t, h, I and a. Line 24 shows the letters printed with the first ink; the non-BFI ink.

Referring also to FIG. 5B, the line of text is shown converted into a line 26 of digital or binary digits of “0” and “1”. “0” has been assigned to characters not printed with BFI; the characters shown in lines 19 and 24. “1” has been assigned to the characters printed with BFI; the characters shown in lines 19 and 22. Line 26 still shows the spaces between the words. Referring also to FIG. 5C, the line 26 is shown without the spaces as line 28. Referring now to FIG. 5D, the digits of line 28 are sectored into four signals 30-33 of eight digits each and a remainder 34. Each of the signals 30-33 symbolize one of the bytes 18 of the signature as seen below the signals (see also FIGS. 4 and 5).

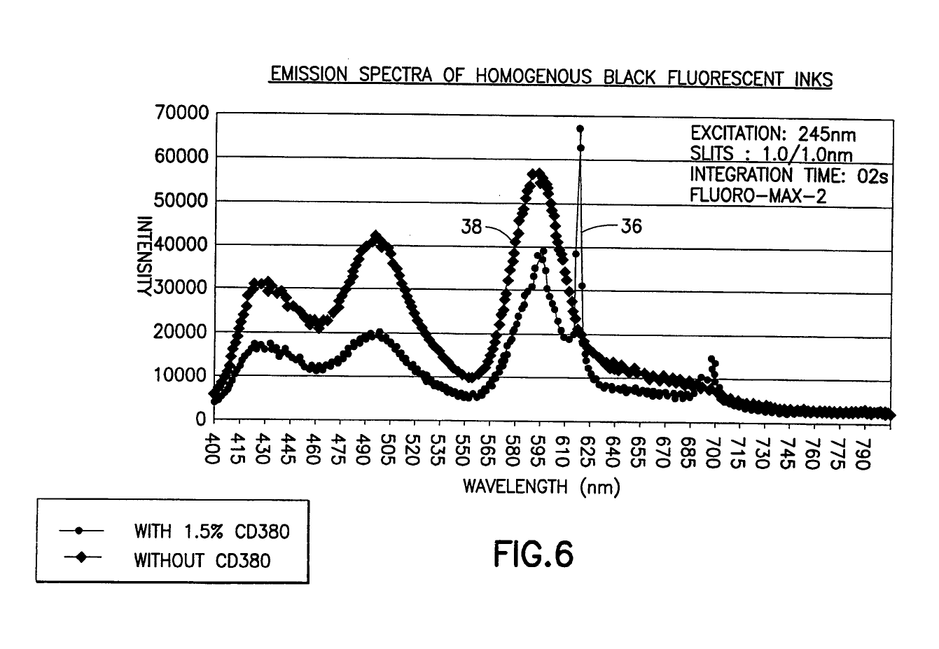

FIG. 6 shows a chart of fluorescence intensity relative to wavelength of two examples 36, 38 of BFI ink which could be used with the present invention as the second ink. One of the examples 36 comprises a rare earth addition of CD380. Printing of postage indicium with a color metameric ink, such as a fluorescent ink or a phosphorescent ink, is described in U.S. patent application Ser. No. 10/692,569 filed Oct. 24, 2003, which is hereby incorporated by reference in its entirety. Dark color fluorescent inks (e.g., dual luminescent) are described in U.S. Pat. Nos. 6,827,769; and 6,793,723; and U.S. patent application publication Nos. US 2002/0195586 A1, US 2003/0005303 A1, and US 2003/0041774 A1, which are hereby incorporated by reference in their entireties. U.S. patent application Ser. No. 10/692,570, which is hereby incorporated by reference in its entirety, describes halftone printing and gray scale printing with multi-signal transmission ink. U.S. Pat. No. 5,153,418 discloses multiple resolution machine readable symbols. IR absorbing ink with IR absorbance could also be used.

In one embodiment of the present invention, the first ink used to print the indicium or document preferably comprises a normal printer ink, such as a non-luminescent black ink as mentioned above for example. The second ink used to print the indicium or document preferably comprises a color luminescent ink, such as a fluorescent ink or a phosphorescent ink, such as described in U.S. patent application Ser. No. 10/692,569 filed Oct. 24, 2003. In a preferred embodiment, the first and second inks have a substantially same color in normal daylight when viewed by a person, such as black for example. Because the second ink is a luminescent ink, it can be excited by a radiation source, such as an Ultraviolet light, to read the second ink separate from other inks. In alternate embodiments, any suitable type of inks (such as metameric inks for example) can be used so long as the inks can be differentiated from one another, but preferably are substantially visually indistinguishable for each other in normal daylight conditions. With the invention, information can be encoded as described in U.S. patent application Ser. No. ______ , filed concurrently herewith (Attorney Docket No. F-942), which is hereby incorporated by reference in its entirety.

The invention can be used with multi-ink metameric codes for optimal information storage. Metamerism is the property where two objects with different spectra produce in the same visual effect. The human-visual system (HVS) sees color through a set of three filters. Any images whose spectra produce the same three signals through these three filters produce the same signal in the HVS. The spectrum of an image depends on the illuminating spectrum. Reflection spectra that are metameric under one lighting source can be distinguished under a different lighting source. Therefore, metamerism should be referred to a particular illumination. An example is black pigment ink and black dye-based ink. The dye-based ink generally has higher reflectance in the red and infrared. In the following, metameric inks refers to two or more inks that appear the same under normal daylight or room illumination. Inks can also differ in their luminescent spectrum. The term luminescence includes phosphorescence and fluorescence. The definition of a metameric ink used herein includes inks that can have different characteristics under certain conditions versus the ink's color under normal lighting. An example is black fluorescent ink.

Encoding in a metameric image can be, for example, used in a multi-level barcode encoding scheme. A metameric encoded image hides information using a set of metameric inks. The metamerism can be detected using a set of sensors with different spectral characteristics that respond differently to the different metameric inks. There is a range of possible encoding schemes. A naive scheme simply uses two (or N) metameric inks and encodes information using any standard two-level (or N-level) barcode such as PostNet, DataMatrix or PDF417. In the two-level case, one ink is used for the normally black portions and a second metameric ink is used for the normally white areas. In the N-level case, ink n is used to encode level n, where n ε {1,2 . . . N}.

A more sophisticated approach would encode information in linear combinations of multiple metameric inks. Consider an image with N metameric inks. There is a relationship f(σ₁, σ₂, . . . σ_{N})=c describing the combinations of densities of inks that produce the same visual effect, where σ₁ is the surface density of ink i. In a simple case this relationship is approximately linear, with a vector of weights wⁱ so that the metameric combinations satisfy Σᵢwⁱσᵢ=c. The weights and surface densities are all positive. Information can be encoded in an image in the combination of σ₁'s used to reach c.

It is desirable to allow c to be a predetermined function c(x, y) of position in the image, so that the image as seen in the HVS is recognizable. Define sᵢ(x, y)=wⁱσ₁(x, y)/c(x, y). The set s₁(x, y) defines a direction independent of c(x, y) in the space spanned by the metameric inks at each point in the image. The sum over the inks satisfies Σᵢsᵢ=1. The naive encoding scheme represents each level by a different ink, that is, simply set Sₙ=1 for the n that corresponds to the encoded information level, and sⱼ=0 for the n≠j. A more complex and higher density encoding can be achieved for two inks by selecting the value s₁ in {0, 1/M, 2/M . . . (M−1)/M, 1} and setting S₂=1−s₁. Now M values can be encoded. For more than two inks, the number of combinations can be increased. For example with three inks and M=3 there are nine combinations of the three s's: (1 0 0) and two permutations, and (⅔, ⅓, 0) and 5 permutations. For 4 metameric inks and M=3 there are 20 combinations so each position can encode over 4 bits. The data can be arranged in a pattern like a barcode.

Continuous watermark encoding can be provided. The phase space watermark is an example of a quasi-continuous grayscale watermark created by adding a linear combination of wavepackets based on some data to an image. A disadvantage of the phase space watermark is that when the image is examined closely, the wavy noise can be seen. The watermark tends to degrade the image quality. Employing two metameric inks allows an improved watermark. Represent the image c(x, y)=c(x, y)·(s₁(x, y)+s₂(x, y)). If the watermark is δ(x, y) then set s₁(x, y)=0.5+δ(x, y) and s₂(x, y)=0.5−δ(x, y). The HVS sees c(x, y), while a detector designed to see the difference between ink 1 and ink 2 sees a signal proportional to δ(x, y).

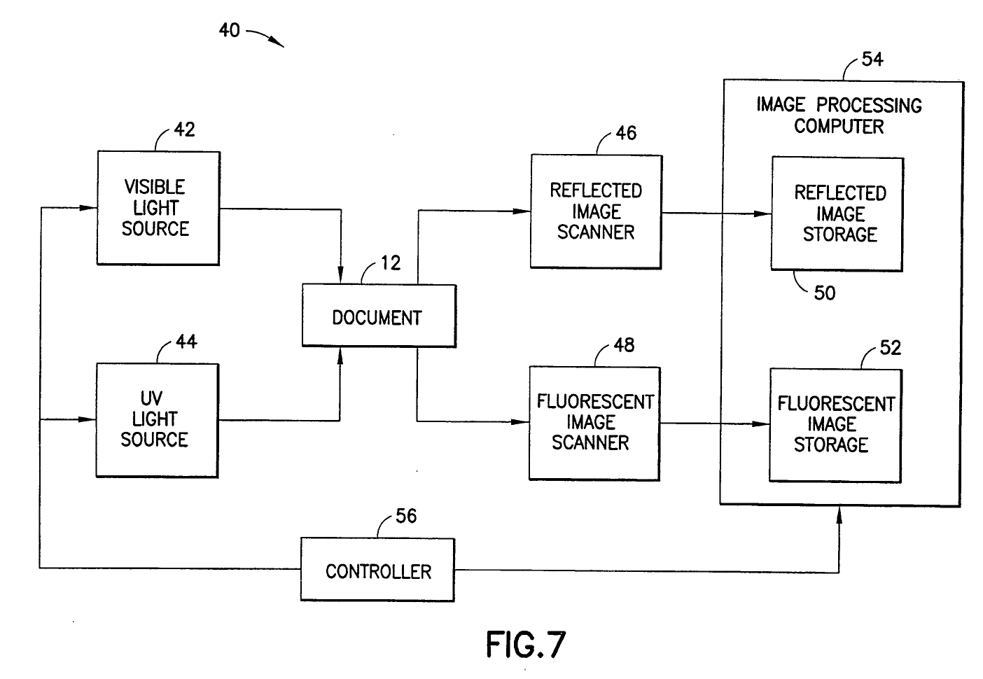

Referring also to FIG. 7, one example of a system 40 for reading the printed indicium or document 12 is shown. FIG. 7 shows a system diagram which includes visible and excitation light sources 42, 44, image capture devices (in this example, they are scanners) 46, 48, storage 50, 52 for multiple images (may be more then two if more then two types of encoding are used) and a processing computer 54, 56 which includes its own memory, software program, algorithms, parameters and interfaces to external systems. The system in FIG. 7 is used to read and decode the information embedded in the document 12. That information can then be passed to another computer system to apply the cryptographic, algorithms and/or the integrity algorithms. In an alternate embodiment, this could be done in the same computer. The document can be scanned under a excitation source, such as UV light 44 or any other suitable excitation source. The resulting image can be converted to text using standard Optical Character Recognition (OCR) methods.

The text is parsed to identify all letters or characters printed with BFI. A binary file is created by assigning a “0” to each non-BFI letter and a “1” to each BFI letter. The resulting binary information will be referred to as “AIR data”. The text and the AIR data are used together to verify/calculate digital signatures or integrity such as by using known numerical methods.

In an alternate embodiment of the present invention, additional information can be encoded using multiple different types of fluorescent or luminescent inks responding to different wavelengths, such as the UV spectrum. Using this method, the density of data that can be encoded can be significantly increased. As such, spectral resolution of the detection system can be enhanced for applications that require higher data density.

The BFI presence can be detected by a simple fluorescence detector for a broad signal; such as 70-80 nm bandwidths for example. Additional information can be encoded using variations of BFI which have unique properties such as phosphorescence, specific narrow emission wavelength of emission, IR absorbance, etc. By using these combinations a user can encode more information that can be read by using different detectors which are respectively sensitive to the unique characteristic. Examples of such characteristics include special signature inks.

An illustration of an ink with a phosphorescent taggant provided by a rare earth complex is shown in FIG. 6. This ink can be identified also with a detector that has special filters for narrow width fluorescence detection (such as 5-10 nm for example) which will differentiate it from a broad band detector. In this embodiment, the difference in fluorescence detection can be obtained by measuring the emission at two different wavelengths: 598 nm for the broad band detector and 616 nm for the narrow band detector.

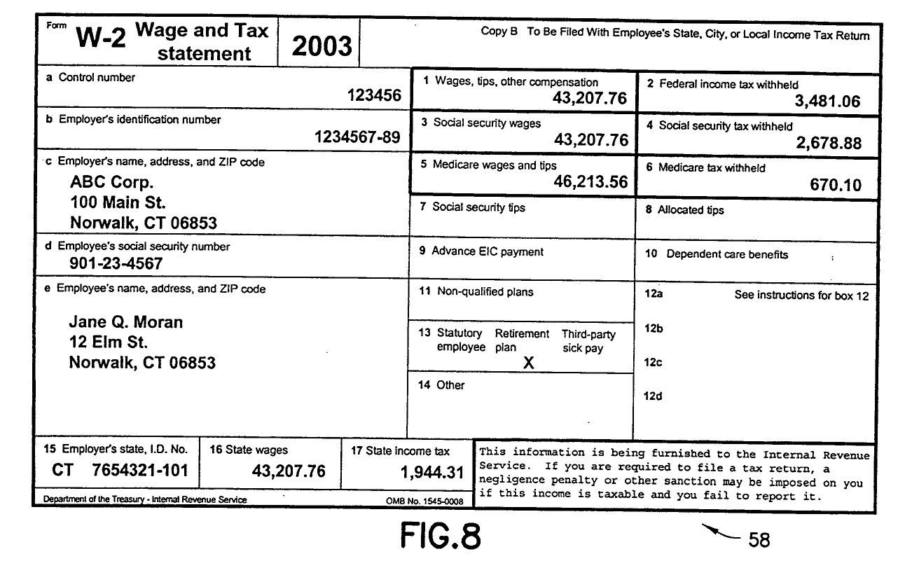

FIGS. 8-10 show one example of use of the present invention in a document. In this example the document is a U.S. tax W-2 form that uses features of the present invention to add authentication and integrity to the printed information. FIG. 8 shows the image 58 of the W-2 form captured with a conventional camera using normal lighting conditions, as it is seen by the human eye. For example, this could be by use of visible light source 42 and reflected image scanner 46 shown in FIG. 7.

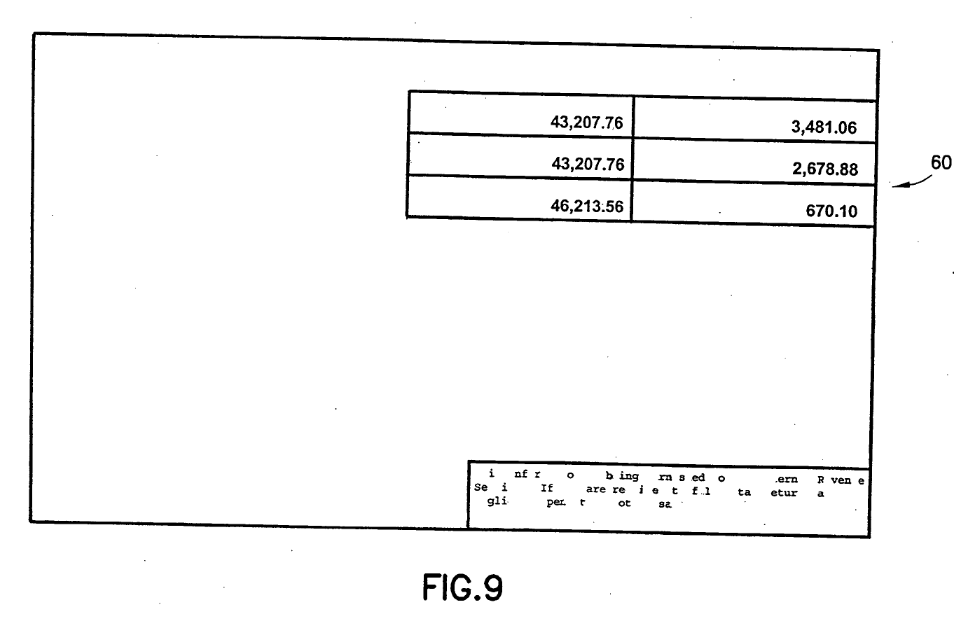

FIG. 9 shows the negative image 60 of the same W-2 form captured with a UV camera with the document exposed to UV light. For example, this could be by use of UV light source 44 and fluorescent image scanner 46 shown in FIG. 7. This image shows the areas (letters, numbers and marks, e.g. lines) that were printed with BFI.

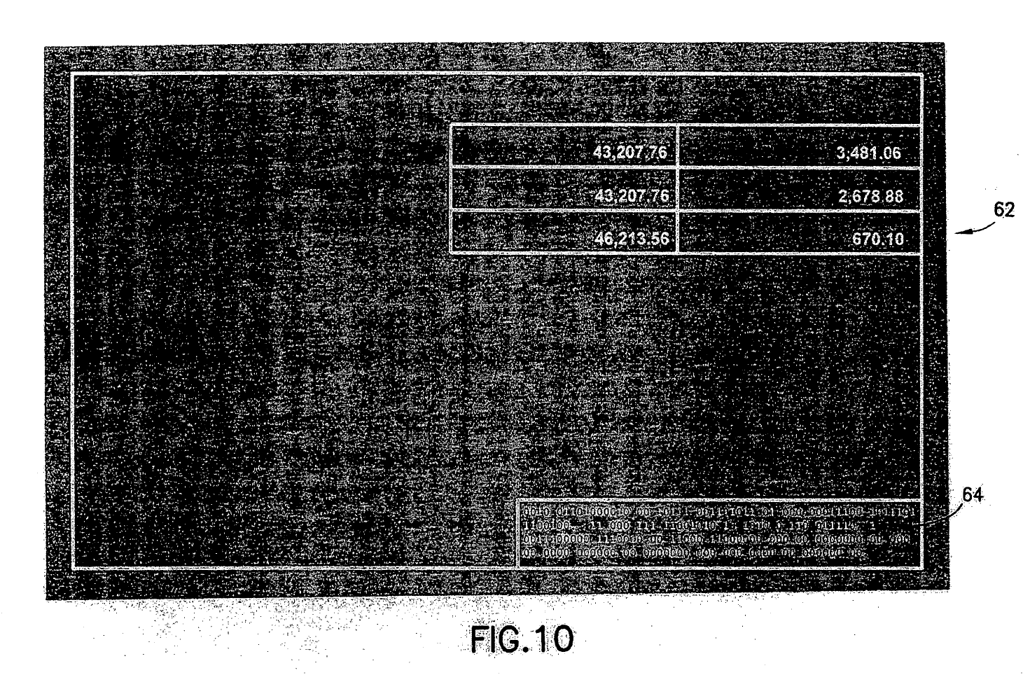

FIG. 10 illustrates the result 62 of processing the images from FIGS. 8 and 9. The text box 64 in the lower right area of the form has encoded information using an algorithm that assigns a binary value of “1” (one) to any letter printed with the special second ink (BFI in this example) and a value of “0” (zero) to all other letters. Punctuation and spaces are not given values. The result of such encoding is a string of digital bits that can be used for message authentication, digital signatures and/or integrity.

The processing of images from FIG. 8 and 9 can rely on correct alignment of the two images. There are a variety of methods to achieve alignment, including the printing of specific marks (crosses, circles, lines) that are visible on both images and coincide or have a known spatial relationship. In this example the lines around the document (border) are used to ensure alignment of the two images. Reference is made to U.S. patent application Ser. No. 10/128,113 which is hereby incorporated by reference in its entirety. Use of known spatial relationships can use one ink and two detectors. The invention can use more than one ink and multiple detectors; or perhaps only one detector with multiple detection capabilities. The detector(s) can be used to establish spatial relationships between/among the characters/symbols printed with different respective inks. This can be understood best with reference to FIG. 5A. When reading the second information stored with the second ink (line 22) spaces between the characters of line 22 can be actual real spaces in the line 20 and/or the characters/symbols printed with the first ink shown in FIG. 24.

The information shown in FIG. 10, in the lower right box 64 can be used for authentication and integrity of the document through known methods such as MAC (Message Authentication Code), digital signatures, error correction codes (for example Reed-Solomon). The numbers in FIG. 10 are representative, not actual calculated values. This system and method can be used for any type of printed document.

In some cases, it is desirable to have the authentication, integrity and/or redundancy capabilities offered by the additional codes described above without making their presence obvious to the casual observer. In other cases, space is at a premium. Hence the capability of applying these codes without taking additional space on the printed area is a definite advantage. Similarly, machine printed and/or machine readable documents can be enhanced using this invention. An example of such applications are proof of payment barcodes applied by postage meters that can use this invention to apply digital signature and redundancy codes. Applying these codes using the method described in this invention does not need to use additional printing area. Additionally, this can be an additional defense against fraudulent copy of the document, as it requires specialized equipment and knowledge.

The present invention can provide a system and method for adding inconspicuous authentication and integrity to printed documents. The present invention can solve the problem of the prior art by adding the codes necessary for authentication, integrity and/or redundancy using a printing method which is not visible under normal conditions and does not interfere with the appearance of the document. An example of such a method is using black fluorescent ink (BFI) to print selected characters of a document. The information used for the digital signature and (or) redundancy purposes is encoded by printing selected characters with a special ink and printing the rest of the document with normal ink.

To the casual observer who examines the document under normal lighting conditions, the document has no additional visible information. When the document is examined under appropriate UV light, selected characters will change color. Their position in the text can be decoded and converted into numbers. These numbers can be used to add digital signatures and/or redundancy to the document. The present invention can be used in various applications including, but not limited to, postage meters, Digital file room (DFR) concept, Database Management Systems (DBMS) document management applications, and document encoding systems. This invention provides a method to add information necessary for authentication and integrity without creating additional visible codes on printed documents and without using additional printing area. This invention describes a method of adding digital signatures and error correction codes to printed documents without altering the appearance of the original document. This invention provides authentication, integrity and redundancy for printed documents without adding any visible artifacts and without using any additional printing area.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A system for storing information comprising:
a first partial portion of a printed marking, wherein the printed marking comprises first information in a first information storage format, and wherein the first partial portion is printed with a first ink; and
a second partial portion of the printed marking, wherein the second partial portion is intermixed with the first partial portion to form the printed marking, wherein the second partial portion is printed with at least one second different ink, and wherein the second ink comprises a metameric ink which becomes excited when exposed to an excitation source such that the printed marking contains second information in a second information storage format which can be read when the printed marking is exposed to the excitation source suitable for reading the second information.

2. A system for storing information as in claim 1 wherein the first information storage format comprises alphanumeric characters.

3. A system for storing information as in claim 1 wherein the first information storage format comprises printed characters and the second information storage format comprises digital aspects of the characters being printed with the first ink and the second ink.

4. A system for storing information as in claim 1 wherein the second information comprises authentication information, or integrity information, or redundancy information of the first information.

5. A system for storing information as in claim 1 wherein the printed marking comprises alphanumeric characters, wherein first ones of the characters are printed with the first ink and second ones of the characters are printed with the second ink.

6. A system for storing information as in claim 5 wherein the first and second inks comprise a substantially same color in normal daylight.

7. A system for storing information as in claim 1 wherein the second information is stored in the printed marking as a relative location relationship format of elements of the first partial portion printed with the first ink relative to elements of the second partial portion printed with the second metameric ink.

8. A system for storing information as in claim 1 further comprising a third partial portion of the printed marking, wherein the third partial portion is printed with a third ink comprising a different metameric ink from the second ink.

9. A system for reading hidden information stored in a printed marking comprising:
a system for exciting portions of the printed marking printed with metameric ink; and
a system for reading locations of the excited portions of the printed marking relative to non-excited portions of the printed marking in a machine readable information storage format to thereby read the hidden information.

10. A system for reading hidden information stored in a printed marking as in claim 9 wherein the system for exciting comprises an Ultraviolet light source.

11. A system for reading hidden information stored in a printed marking as in claim 9 wherein the printed marking comprises alphanumeric characters, and wherein the machine readable information storage format comprises digital aspects of the characters being printed with metameric ink to form the excited portions and non-metameric ink to form the non-excited portions.

12. A system for reading hidden information stored in a printed marking as in claim 9 further comprising determining a digital signature, or a Message Authentication Code (MAC), or an error correction code based upon the hidden information.

13. A system for reading hidden information stored in a printed marking as in claim 9 further comprising using an authentication and integrity process based upon the hidden information to authenticate information in a unified combined reading of elements which form the excited and non-excited portions.

14. A system for printing a printed marking on a mail piece, the system comprising:
a printer adapted to print on the mail piece with at least two different inks; and
a controller adapted to control printing of the at least two inks by the printer on the mail piece, wherein the controller is adapted to print a first portion of the marking with a first one of the inks and a second portion with a second different one of the inks, wherein the second ink comprises a metameric ink, wherein the first and second inks comprise a substantially same color in normal daylight, and wherein the second portion of the printed marking is adapted to be read separately from the first portion by a metameric ink reading to convey additional information in addition to a normal daylight information conveyance of the marking.

15. A system as in claim 14 wherein the controller is adapted to print the first and second portions of the marking with an encoded format to convey the additional information in an encoded form by an arrangement of the first and/or second sections.

16. A system as in claim 14 wherein the controller is adapted to print the first portion as characters and/or symbols of the marking intermixed with the second portion as characters and/or symbols of the marking.

17. A method of printing a printed marking comprising:
determining first portions of the printed marking which are to be printed with a first ink and second portions of the printed marking which are to be printed with a second different ink, wherein the first and second portions provide a first information;
printing the first portions with the first ink; and
printing the second portions with the second ink, wherein the second ink comprises metameric ink, and wherein positions of the first portions relative to the second portions provide a second machine readable information.

18. A method as in claim 17 wherein printing the first portions and the second portions comprises printing alphanumeric characters.

19. A method as in claim 17 wherein printing the first portions and the second portions comprises printing the second portions intermixed with the first portions.

20. A method as in claim 17 wherein the second machine readable information digital signal information.

21. A method of authenticating a printed marking comprising:
reading the printed marking using a first information reading format; and
reading the printed marking using a second different information reading format, wherein reading the printed marking using a second different information reading format comprises exciting second portions of the printed marking with an excitation source and determining locations of the second portions relative to at least some first portions of the printed marking.

22. A method as in claim 21 wherein reading the printed marking using the first information reading format comprises optical character recognition.

23. A method as in claim 21 wherein reading the printed marking using the second different information reading format comprises assigning first digital references to the first portions and second digital references to the second portions.

24. A method as in claim 21 wherein reading the printed marking using the second different information reading format comprises using an authentication and integrity process based upon hidden information in the printed marking to authenticate information in a unified combined reading of the first and second portions.
